(19) United States
(12) Patent Application Publication
(10) Pub. No.: US 2008/0104617 A1
(43) Pub. Date: May 1, 2008

(54) EXTENSIBLE USER INTERFACE

(75) Inventors: Johnson T. Apacible, Mercer Island, WA (US); Sean Patrick Nolan, Bellevue, WA (US); Jeffrey Dick Jones, Woodinville, WA (US); Ryszard K. Kott, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/759,361

(22) Filed: Jun. 7, 2007

Related U.S. Application Data
(60) Provisional application No. 60/863,897, filed on Nov. 1, 2006.

(51) Int. Cl. G06F 3/00

(52) U.S. Cl. 719/328

(57) ABSTRACT

A user interface is provided for rendering platform data to an output device. The data is sent to the user interface from the protocol along with self-describing rendering information. This information can be in a transform format, such as extensible stylesheet language (XSL) and the like, and/or code-based language such as an object-oriented language, sequential language, hierarchical (such as XML) and the like. The user interface utilizes the self-describing rendering information (and/or a rendering method contained therein) to render the data to the output device. In this regard, the user interface is extensible by modifying the self-describing rendering information, which mitigates the need for additional development to the user interface when rendering methods change (for new field additions, cosmetic preferences, etc.).

### CROSS-REFERENCE TO RELATED APPLICATION(S)

This application claims the benefit of U.S. Provisional Patent Application Ser. No. 60/863,897 filed on Nov. 1, 2006, entitled “INTERACTIVE AND INTUITIVE HEALTH AND FITNESS TRACKING,” the entirety of which is incorporated herein by reference.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

For example, collaborative social networking websites have exploded world-wide. These sites allow users to create remotely stored profiles including personal data such as age, gender, schools attended, graduating class, places of employment, etc. The sites subsequently allow other users to search the foregoing criteria in an attempt to locate other users—be it to find a companion with similar interests or locate a long lost friend from high school. As another more practical example, banking websites offer users the ability to remotely store information concerning bills to be paid. By utilizing this feature, users can automatically schedule bill payments to be made from their bank account which will be automatically debited when the payment is scheduled. This allows simultaneous electronic management of account balancing and bill paying such to save the user from manually entering checks into the register of their checkbook.

These websites are typically implemented with a particular focus of functionality and offered data determined before release of the site. Improvements to the system often require an additional software release on the server and sometimes the client-side as well. In particular, adding new data to the system or even making a cosmetic change in the appearance and/or layout of the existing data will often require new implementation to account for the changes at least on the server side. Where the client is a thick-application, for example (and not merely a web browser or client to software as a service), code changes will be required on that application as well. Often times compliance with upgrade on the client-side is required even where the application has never used the portion of software or data that is being upgraded. These limitations, with respect to adding new data and/or changing or adding new layouts or renderings of the data, are becoming more problematic as data of broader context becomes remotely available and disparate applications are seeking to access each other's data.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

An extensible user interface that facilitates receiving data along with self-describing rendering information is provided where the self-describing rendering information comprises one or more rendering methods that can be used to render the associated data. The self-describing rendering information can be, for example, a plurality of rendering methods of a transform type of functionality, such as extensible stylesheet language (XSL) and the like, and/or a software code type of rendering, such as an object-oriented code representation, an extensible markup language (XML) representation and the like. The data can be received from a platform in connection with a request made for the data. The data can comprise many different values that represent a collection of related data. Thus, the self-describing rendering information allows the user interface to layout the data as specified by the platform rather than requiring pre-coded software to effectuate the rendering. In this way, the user interface is extensible since data can have associated layouts at the time of storage within the platform, for example, and need not know the layout of the data it is going to display before being implemented.

In one embodiment, the platform can be a health integration network comprising a plurality of databases that respectively store health and/or fitness related data. The request can originate from a software application running a graphical user interface (GUI) that can utilize the user interface as described herein, for example. The GUI can initiate a request for data about a doctor's visit, for instance. The data requested in this regard can be of different format. For example, a blood pressure reading can be returned along with a weight, vitals, diagnosis, prescription, co-pay, etc. The self-describing rendering information can provide, for example, one or more XSL documents that define various possible layouts for the data. The XSL can take the different pieces of the data into account in offering the rendering such that blood pressure can be displayed as “systolic/diastolic” rather than two integers (as it is likely stored and communicated), for example. Moreover, in this or another embodiment, the self-describing rendering information returned from the platform can be related to a context (such as user and/or application, etc.) of the request such that the rendering of the information makes sense for the requesting user. For example, if a patient is requesting access to a doctor's visit, the rendering methods offered can be different from a doctor requesting the information (different terminologies, more or less data about the visit, etc.).

Furthermore, the self-describing rendering information can provide rendering methods to display data as a simple text string, for example. More particularly, the information can provide instruction, code, rules, and/or methods to display the data in a tabular format such that like items are displayed with common information as rows or columns of the table. Using this interface, a more detailed screen displaying the common information as well as information specific to the entry can pop-up upon engaging the row or column related to the data (such as by mouse-click and/or mouse-over in a computer display environment). Additionally, data can be rendered in a two- (and/or three- or n-) dimensional layout by utilizing positioning information and/or vector graphic code, etc.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that facilitates rendering data via a user interface component.

FIG. 2 illustrates a block diagram of an exemplary user interface component.

FIG. 3 illustrates a block diagram of an exemplary system that facilitates rendering data from components of a health integration network.

FIG. 4 illustrates an exemplary data rendering using a layout rendering method.

FIG. 5-9 illustrate exemplary user interface displays.

FIG. 10 illustrates an exemplary flow chart for rendering received data.

FIG. 11 illustrates an exemplary flow chart for calling the platform while rendering received data.

FIG. 12 illustrates an exemplary flow chart for wrapping common user interface methods in web controls.

FIG. 13 is a schematic block diagram illustrating a suitable operating environment.

FIG. 14 is a schematic block diagram of a sample-computing environment.

### DETAILED DESCRIPTION

A user interface (UI) is provided to facilitate outputting data upon request; the UI is extensible, for example where the data to be output can change structure and the UI can properly output the data as changed without requiring additional changes and/or implementation to the UI itself. The UI can retrieve (and/or receive) data from a source (such as a platform), and data can be packaged with self-describing rendering information. The UI can utilize this information to display the data; in this regard, the data layout can change by modifying the self-describing rendering information such that the UI can utilize the same implementation details to display the added data according to the modified self-describing rendering information. Thus, the UI can be extensible without requiring additional code releases. In one embodiment, the data retrieved and/or received by the UI for display can be an extensible markup language (XML) document, for example. Due to the extensible nature of XML, the data can easily take-on additional fields and the UI can display the fields without knowing the structure beforehand. To facilitate this behavior, the XML document comprising the data can also include rendering instructions, information, and/or code to properly format the data in a variety of fashions. When fields are added to the XML, additional self-rendering information can be added as well for those new fields. For example, a blood pressure can be requested and returned as an XML document comprising separated values for the systolic and diastolic pressures. The rendering information sent along with the reading can, for example, specify code to translate the pressures into a string taking the form “systolic/diastolic” as is conventionally used in blood pressure context. The UI can leverage this code to make the transformation and display the result. In this way, the UI need not know how to layout the data, rather this information can be specified in connection with the data and sent along with a request to the data. It is to be appreciated that multiple rendering methods can be stored and provided.

In another embodiment, the data can be displayed in a tabular format. For example, data retrieved and/or received that relates to an underlying structure, can be displayed such that the related data is output together in a table providing value to the data. For example, a record relating to a prescription can display multiple values such as prescription name, strength, dosage, amount prescribed, date of fulfillment, date of last refill, refills remaining, etc. In this example, the data is of different types—strings, dates, integers, and the like. However, the record can be packaged with rendering information and/or code (or rules, for example) that can be utilized to display the information correctly and in a format that makes sense given the data. Thus, the subject matter described is not limited to data layouts pre-coded in the UI; rather since the UI is extensible through the data and rendering information provided along with requested/retrieved data, different records of different types can have their own outputs as defined in the rendering information.

In yet another embodiment, a two dimensional rendering of a multiple field layout can be specified by the self-describing rendering information. The layout can be described in a variety of formats having executable code to actually render the data, for example. Positioning information can be defined (using absolute and/or relative positions, for example) for the different fields comprising the data type. In this regard, a desirably formatted screen can be designed using the available data and the UI can display it by merely utilizing the code provided in the rendering information. Thus, in the context of a multi-application platform, the entity that created the data type in the platform can have control over the display of the data in other applications or interfaces, for example, since the creating application can specify the self-describing rendering information. It is to be appreciated that the rendering information can be returned from the source of the data based at least in part on context of the requesting entity (such as a user or application making the request). For example, in a platform that stores health related data, a patient viewing their medical chart may not need to view all of the information associated therewith (and in fact some information can be more confusing than if it were left out); however the doctor may want to see all of the information. In this regard, the platform can specify different self-rendering information to each UI (which can be different instances of the same UI) in both contexts (depending on who is requesting the data, for example). It is to be appreciated that multiple types of display are possible include 3-dimensional displays, such as a holographic display or other multi-dimensional displays.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

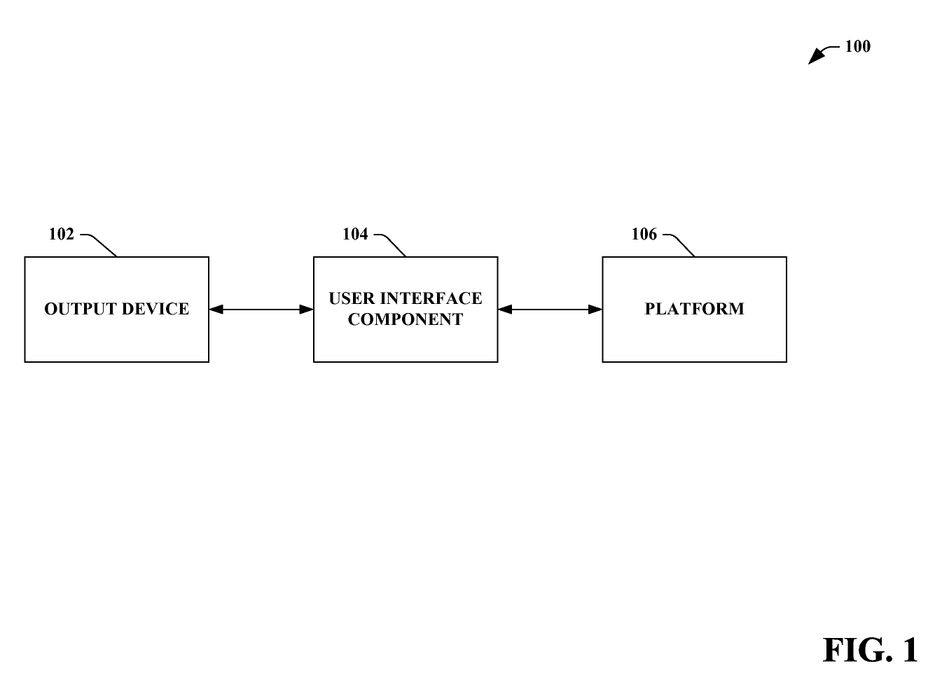

Now turning to the figures, FIG. 1 illustrates a system 100 that facilitates outputting data retrieved from a platform. An output device 102 is provided that receives data to be output to a user, for example. A user interface component 104 is also provided to prepare the data for the output device 102 and a platform 106 provides access to data desired by the output device 102. A request for data can be sent to the user interface component 104, for example, by the output device 102, another device/application, and/or specified within the system. The request for data can be sent to the platform 106, and a result is received by the user interface component 104 from the platform 106. The result can comprise the desired data as well as self-rendering information for the data.

For example, the data request can be for health and/or fitness related data such as fitness activities performed in the past week for a given user defined by the platform 106. This data comprises different types of data, the rendering of which can be complicated. The data can comprise a run, some weightlifting sessions, and biking, for example. The run can have values for duration, location, time, heart rate (if using a heart rate watch, for instance), and the like. The weightlifting can comprise multiple lifts, each having a number of sets and repetitions performed, time, location, duration, etc., and the biking can have time, location, duration, average speed, peak speed, elevation/altitude or hill grade information, and the like. While there are some values common to all of this data (time, location, duration), there are also specialized values for each (heart rate, sets/repetitions of lifts, average speed, etc.). The user interface component 104 can request the data from the platform 106 and receive the data in an extensible format (such as XML), for example. Upon receiving the data, the user interface component 104 can utilize self-describing rendering information about the data to present it to the user via the output device 102. In one embodiment, the user interface component 104 can gather the related data in a tabular format and output the data to the output device 102, which can be a display in this embodiment. The user interface component 104 can further provide the specialized information when interest is expressed in the given fitness session; for example, a user can select and/or mouse-over the fitness table entries to get more detailed information which can include the specialized information for each of the activities. Additionally, the self-describing rendering information can be wrapped in a web control by the user interface component 104 for easy re-use in other applications. The user interface component 104 can also package sets of commonly executed methods to be deployed at a remote system desiring to utilize the UI. This packaging can be chosen using artificial intelligence techniques, for example.

It is to be appreciated that the output device 102 can be many devices, applications, users, and the like. For example, the output device 102 can be a personal health device (such as a blood pressure or glucose level monitor, pacemaker, heart rate monitor, fitness watch, etc.), a software application (such as a graphical user interface (GUI), a management application, a data aggregation component for multiple proprietary health information systems, and the like), and/or a software application for legacy health and fitness data devices. Additionally, the output device 102 can be commercial health devices such as surgical and/or hospital room equipment having auditory alarms. Specifically, the output device 102 can be such an auditory alarm and/or central alarm system for example. In one embodiment, an oxygen pump in a hospital patient room (which can also be an output device 102) can be detected as failing. The platform 106 can send an alert to the user interface component 104 for a central alarm panel (which is the output device 102 in this embodiment), and the user interface 104 can receive code in self-describing rendering information for the data type representing the oxygen pump statistics. The code can be such to invoke an alarm on the output device 102, and the user interface component 104 can render the data in that regard. Additionally, the code can provide a digital readout rendering for the central alarm or one or more light emitting diodes (LED) on the central alarm panel, for example.

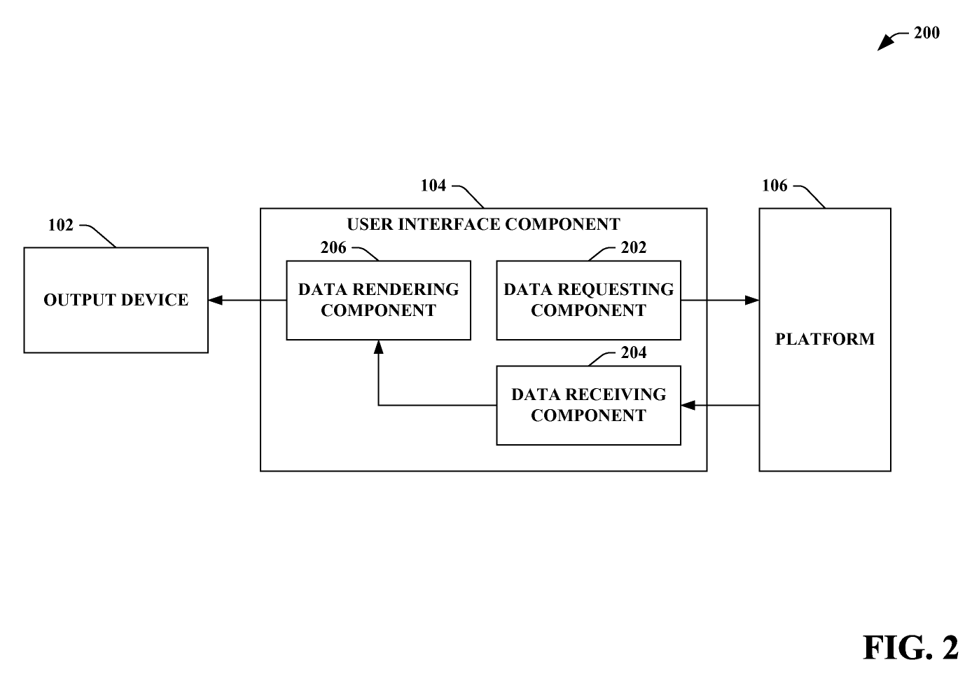

Referring to FIG. 2, a system 200 for requesting, receiving, and displaying data is shown. An output device 102 is provided to render the data received according to instruction from the user interface component 104. The user interface component comprises a data requesting component 202 that requests data from a platform 106, a data receiving component 204 that receives a response from the platform 106 (based on the request), and a data rendering component 206 that renders the received data according to rendering instructions resident in the received data. The data requesting component 202 can be used to request data from a platform 106; the request can be specified by the output device 102 or a component associated therewith. For example, an application, which utilizes the user interface component 104 to display data to a user, can forward a request for data to the user interface component 104 on behalf of the output device 102. In an embodiment, this can be, for example, a blood pressure monitor that requests a previous reading to be displayed on a liquid crystal display (LCD) associated with and/or resident on the blood pressure monitor. The user interface component 104 can communicate with the blood pressure monitor and/or the LCD directly to render the previous reading data obtained from the platform 106.

The user interface component 104 can forward requests for data to the platform 106 along with any additional information provided for context, authentication/authorization, etc. Additionally, the data requesting component 202 can make a request to open a communication channel with the platform 106 on behalf a requesting device (which can be the output device 102), for example, to receive updates, alerts, events, etc. In the example provided above, the centralized alarm system can use this configuration to receive the event of the failing oxygen pump. Upon making a request for data (whether in request/response or subscription mode) to the platform 106, the data receiving component 204 of the user interface component 104 can eventually receive a response correlating to the request. The data received in the response can include self-describing rendering information. This can comprise multiple rendering methods from which the user interface component 104 can choose for rendering. Also, it is to be appreciated that the platform 106 can make decisions about which rendering methods and/or code to return based on context information specified by the data requesting component 202. For example, the data can be requested from an application, which can be the output device 102, in which a user can be logged in. The user can desire information regarding prescriptions for example. The data receiving component 204 of the user interface component 104 can receive the requested data along with rendering information, where the rendering information relates to data in which the user would be interested and can exclude a portion of the data stored in the platform 106 (such as class of a medication, for example). In contrast, if a physician is logged in the system, the rendering information sent to the data receiving component 204 along with the data can comprise information for rendering data that the physician would care to see, which can include all stored information about the prescription and drug, for example. Moreover, it is to be appreciated that the self-describing rendering information can be provided based on accessibility of the data and/or the rendering instruction(s), urgency of the data (such that instructions can provide for data that is efficiently rendered where needed if desired). Additionally, the self-describing rendering information can be populated and/or delivered based in part on environmental concerns, such as display type, device type (or substantially any concerns related thereto such as processing power, memory constraints, etc.), and/or bandwidth capability of the display, device, network to which it is connected, and the like.

Upon receiving data and self-describing rendering information, the user interface component 104 can utilize a data rendering component 206 to apply the rendering instructions to the data. Subsequently, the rendered data can be output to the output device 102 (as text, graphics, other visual display, audio, or as an analog or digital signal to cause some process, electronic signal, and the like). The self-describing rendering data can comprise, for example, extensible stylesheet language (XSL) to render XML representations of the data value(s) requested into text strings, HTML pages, and the like. Additionally, the XSL can render the requested data into any text format. The XSL can be stored in within the platform in conjunction with a data type for the data requested such that data of the same type can offer the same rendering options when returned by the platform 106. It is to be appreciated that multiple rendering options can be provided, for example, XSL can be provided to render the data in many different ways including predefined formats, such as HTML pages, structured XML documents, really simple syndication (RSS) format, plain text string, some proprietary or other format used in specific applications, and the like. In this way, the data rendering component 206 can choose the appropriate rendering method and/or code for the context. In another embodiment, the user or entity using the output device 102 can choose a rendering method available within the data type for the data, for example, by specifying the rendering method in the original call for data. Moreover, the rendering information can be located remotely, and the call for the data can call the rendering method on the requested data by reference to the rendering method. For example, providers can develop alternative rendering methods external to the platform, and the external rendering method can be utilized. It is to be appreciated that the external rendering method can also be provided by the application and/or manufacturer of a device used to input the data.

In one embodiment, the self-describing rendering information can be software code (such as XML, object-oriented languages, and/or pseudo-code, etc.); the software can provide further intelligent operations with respect to the data. It is to be appreciated that a set of rules can also be used. The operations can use additional data and/or services of the platform 106 to provide additional information and/or value to the data. For example, the code can provide additional context to be determined regarding the data and the data rendering component 206 can render additional data based on the outcome of the code. In one example, the data can be related to personal health and fitness data, such as prescription medication data, and the platform 106 can facilitate storing and retrieve such information. The data requesting component 202 can receive and forward a request for prescription information on behalf of a user of the platform 106. The platform 106 can return the relevant data regarding prescriptions to the data receiving component 204. The data rendering component 206 can then analyze the self-describing rendering information sent with the data that can comprise additional software code, representing additional calls for information to the platform 106 for example. The calls can be to request data about drugs in the prescription information with respect to active ingredients. The code can also request allergy information about the user from the platform 106. Upon receiving these values, the code can compare the active ingredients of the drug with allergies of the user to determine if the active ingredients can cause allergic reaction. If such information is received in the positive, the code can cause the data rendering component 206 to additionally display a notification with the data when rendered to the output device 102. In this regard, rules for displaying data are bound to the data such that they can change without requiring changes in the UI to display the modification in the layout. This is beneficial as it allows extensibility of the presentation of the data by changing values stored with the data and not requiring new releases of executable software code. It is to be appreciated that this is just one embodiment and many others can be imagined, and are intended to be covered, in many different platforms. Additionally, code can be included along with transform information (such as XSL) to provide broad functionality along with efficiency and extensibility.

In another embodiment, the data receiving component 204 and/or the data rendering component 206 can, for example, detect the data requested and retrieved from the platform by a given user and target advertising based at least in part on this detection. It is to be appreciated that this determination can be made by the platform 106 as well, and transform data given to the data rendering component 206 can comprise this advertisement data as well as rendering information for the data. For example, a user of the interface can enter workout information for a series of running sessions and this can be detected. After a threshold is met (as far as number of sessions entered, for example), advertising for watches that can automatically track fitness session information can be displayed by the data rendering component 206 to the output device 102, for example. As described, this information can be sent along with a request from the platform 106 as well. As another example, ads for fitness apparel or running shoes, for example, can be rendered as well. Additionally, the advertisement data can be part of the transform(s) itself.

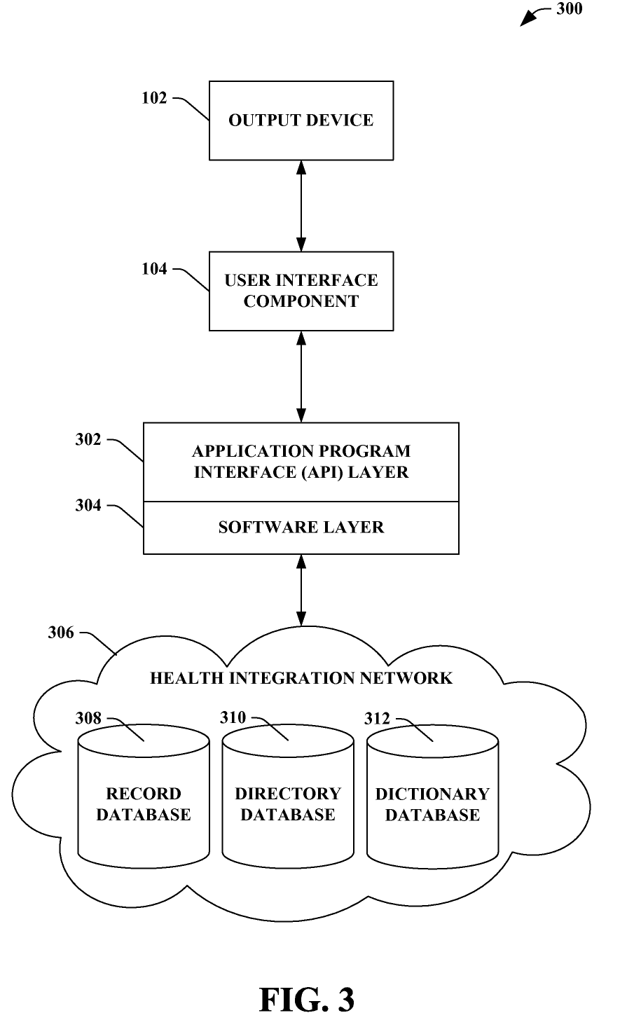

Referring to FIG. 3, an example system 300 that facilitates accessing information within a health integration network is shown. An output device (application, device, user, etc.) 102 can at least one of display or specify health related data. It is to be appreciated that the output device 102 can be many different types of applications including software applications, electronic devices executing a software application, electronic devices alone, legacy devices interfaceable with a device executing a software application, and the like. The output device 102 can utilize a user interface component 104 to request and render data for display (or other output, such as auditory) to the output device 102. Requests to the user interface component 104 can be forwarded to an application program interface (API) 302 to request and store data within a health integration network 306. It is to be appreciated that the API 302 can synchronously or asynchronously communicate with a plurality of user interface components 104 of similar or different types. The API 302 can also have a software layer 304 to leverage in interpreting and processing the request. The software layer 304 can be separated out as shown, or it can be integrated within the API 302, the health integration network 306, or both. Upon interpreting and processing a request from the user interface component 104 (that can originate from an application and/or output device 102), the software layer 304 can access the health integration network 306 for any necessary data or to store necessary data to fulfill the request. The software layer 304 can also provide value to the data such as assembling data from the health integration network 306, applying business models or processes in conjunction with data, caching data, and/or applying transformations or additional information to/with the data. It is to be appreciated that there may be a plurality of APIs 302 and software layers 304 connecting to a centralized health integration network 306, and the centralized health integration network 306 may be a single system or distributed across multiple systems, platforms, and the like. Additionally, a plurality of user-interface components 104 can leverage the API 302 (or utilize a software development kit that utilizes the API 302, for example).

The health integration network 306 can comprise a plurality of data stores including a record database 308, a directory database 310, and a dictionary database 312. In addition, the health integration network 306 can comprise many other systems and/or layers to facilitate data management and transfer. Furthermore, the databases can be redundant such that multiple versions of each database are available for other APIs and applications and/or a back-up source for other versions of the databases (to provide redundancy, for example). Additionally, the databases can be logically partitioned among various physical data stores to allow efficient access for highly accessed systems. Moreover, the databases can be hierarchically based, such as XML and/or relationally based. The record database 308 can be highly distributed and comprise personal health related data records for a plurality of users. The records can be of different formats and can comprise any kind of data (single instance, structured or unstructured), such as plain data, data and associated type information, self-describing data (by way of associated schemas, such as XSL schemas for example), data with associated templates (by way of stylesheets for example), data with units (such as data with conversion instructions), binary data (such as pictures, x-rays, etc.), and the like. Moreover, the record database 308 can keep an audit trail of changes made to the records for tracking and restoration purposes. Additionally, any data type or related instances of the foregoing information can be stored in a disparate database such as the dictionary database 312 described infra. The record database 308 can be partitioned, distributed, and/or segmented based on a number of factors including performance, logical grouping of users (e.g. users of the same company, family, and the like).

The directory database 310 can store information such as user account data, which can include user name, authentication credentials, the existence of records for the user, etc. The directory database 310 can also house information about records themselves including the user to whom they belong, where the record is held (in a distributed record database 308 configuration) authorization rules for the records, etc. For example, a user can specify that a spouse have access to his/her fitness related data, but not medical health related data. In this way, a user can protect his/her data while allowing appropriate parties (such as spouse, doctor, insurance company, personal trainer, etc.) or applications/devices (blood pressure machine, pacemaker, fitness watch, etc.) to have access to relevant data. In addition, the directory database 310 can comprise data regarding configuring applications and/or output device 102, and user interface components 104, to interact with the health integration network 306; applications, output devices 102, and/or user interface components 104, can be required to register with the health integration network 306, and thus, the application/output device/user interface component data in the directory database 310 includes the registration information.

The dictionary database 312 can hold information relating to vocabulary definitions used by the health integration network 306 and requesting entities such as the API 302, software layer 304, user interface component 104, and output device 102. Such definitions can include data type definitions and information on how to display the different data types or transform them. Additionally, the dictionary database 312 can hold information for display layouts and templates, etc. Furthermore, the dictionary database 312 can hold different look-up tables that define codes through the use of standards and the like. For example, the dictionary database 312 can support International Classification of Diseases, ninth revision (ICD-9) released by the National Center for Health Statistics. These codes identify different diseases and diagnoses; thus a doctor can put one of these codes on a user's chart in the health integration network 306, and the dictionary database 312 can allow the software layer 304 (or API 302, user interface component 104, and/or output device 102) to translate this code into something that makes more sense to the user, such as medical name and/or different, other, or additional information concerning the diagnosis. The dictionary database 312 can also be used to retrieve other metadata such as plural and abbreviated forms of codes (such as ICD-9 codes). It can also hold information that allows conversion between different measurement units, such as between feet to meters, Fahrenheit to Celsius, pounds to kilograms, etc. For example, the dictionary database 312 can also hold values for the self-describing rendering information as described above (including XML code, object-oriented code, pseudo-code, XSL, etc.).

In one embodiment, the output device 102, which can be more than one application, device, and/or user utilizing a GUI for example, can make a call to the user interface component 104. The call can then be forwarded to an API 302 to request, store, or modify data, for example. The API 302 leverages the software layer 304 to process the call made by the output device 102. The software layer 304 can then query its own internal cache or the health integration network 306 for desired data; additionally or alternatively, the software layer 304 can directly query one or a plurality of the databases 308, 310, and 312 for the desired data. The software layer 304 can serially or asynchronously query for data until all data is obtained from the health integration network 306. The software layer 304 can then manipulate portions of the data using other data it has obtained to formulate the result desired by the output device 102 (and/or user interface component 104) and return that result to the user interface component 104 via the API 302. The user interface component 104 can then render the data, using the methods described supra, for output to the output device 102.

For example, an output device 102 can be a blood pressure monitor and can request a user's blood pressure reading by using the user interface component 104 to call the API 302, which in turn can communicate with the software layer 304 to formulate the desired reading. The software layer 304 can query, directly or through the health integration network 306, the directory database 310 to obtain the location of the blood pressure reading, the dictionary database 312 to obtain self-describing rendering information, schema, style, and general type information for blood pressure types, and the record database 308 to obtain the actual reading. The software layer 304 can submit the values and describing data to the API 302, which can send the information back to the user interface component 104. The user interface component 104 can then utilize the self-describing rendering information to render the data to the output device 102 in the appropriate format. As described, the user interface component 104 can use context and/or output device 102 information to choose the rendering style. For example, one of the rendering styles available can be for a blood pressure monitor and the user interface component 104 can return that representation of the data. It is to be appreciated that the subject matter described is not so limited to the foregoing example/embodiment, but rather this is one of many possible embodiments of the API 104 that interfaces with a health integration network 304.

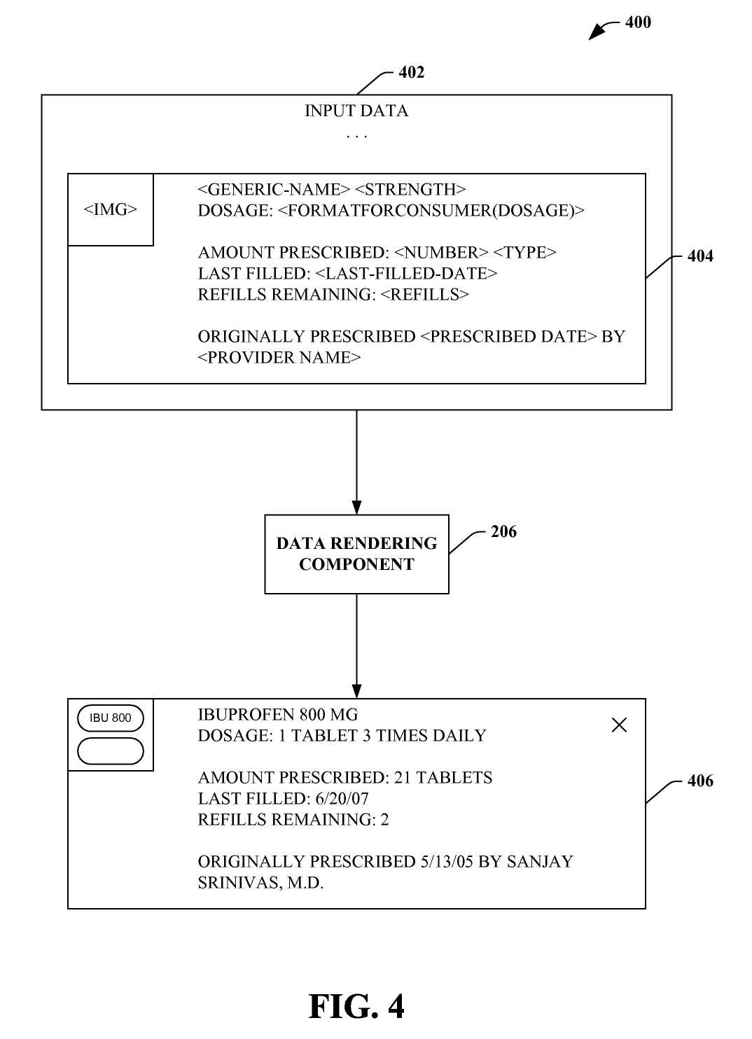

Turning now to FIG. 4, a system 400 for rendering input data and an abstract data layout into formatted data is shown. A data rendering component 206 is provided that takes input data 402 as input. Input data 402 can comprise data values (structured and/or unstructured) as well as rendering method comprised in self-describing rendering information for data, the rendering method is in the form of a graphical layout 404. It is to be appreciated that this graphical layout 404 can be defined using many graphical techniques, such as coordinate positions, scalable vector graphics (SVG), executable drawing code, and the like. In addition, the graphical layout 404 can be specified in a format defined by and/or understood by the data rendering component 206. As described above, the input data 402 can be stored in and sent by a platform, such as a health integration network. The input data 402 can be sent along with the graphical layout 404 by the platform. It is to be appreciated that other layout data and/or self-describing rendering information can be sent with the data in addition to the graphical layout 404.

In this embodiment, the data rendering component 206 utilizes the graphical layout 404 definition to render the input data provided into a resulting graphical rendering 406 to be displayed by a digital display device, for example. The data rendering component 206 knows how to appropriately leverage the self-describing rendering information (e.g. the graphical layout 404) to produce the desired graphical rendering 406. The input data 402 in this embodiment can provide the data values to be used in creating the graphical rendering 406, such as the generic-name, strength, etc. in this embodiment. Additionally, code can be provided in the self-describing rendering information such as FormatForConsumer(Dosage). This function can be provided in the information and can take in the dosage provided in the input data. The data rendering component 206 can utilize the platform sending the data to execute this code to provide the desired rendering. For example, the platform can decide to send this functionality in the self-describing rendering information based on the context of the requesting entity. In this example, the requester can be a user and the UI can process the FormatForConsumer request to format the dosage in a “1 table 3 times daily” type of format. If a physician was making the request, for example, the platform might choose to expose a FormatForPhysician(Dosage) call to render the dosage as “1 tab. po tid” for example. It is to be appreciated that many rendering instructions can be submitted with requested data to support a variety of interfaces; as well, these instructions are extensible to add new rendering options without requiring code changes to the user interface (the user interface can allow a user to request an output format for example). Also, a device that may not have many options (such as blood pressure monitor) can be manufactured to ask only for a certain rendering and the platform can send that rendering to the data rendering component 206 every time, or based on the context of the requesting entity/output device being the blood pressure monitor. In this way, disparate devices can also use each others data; for example, multiple brands of a certain device can define rendering instructions for the same type of data. Then data originating from one device can be requested by another, but the rendering information defined by the requesting device can be used to render the data.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

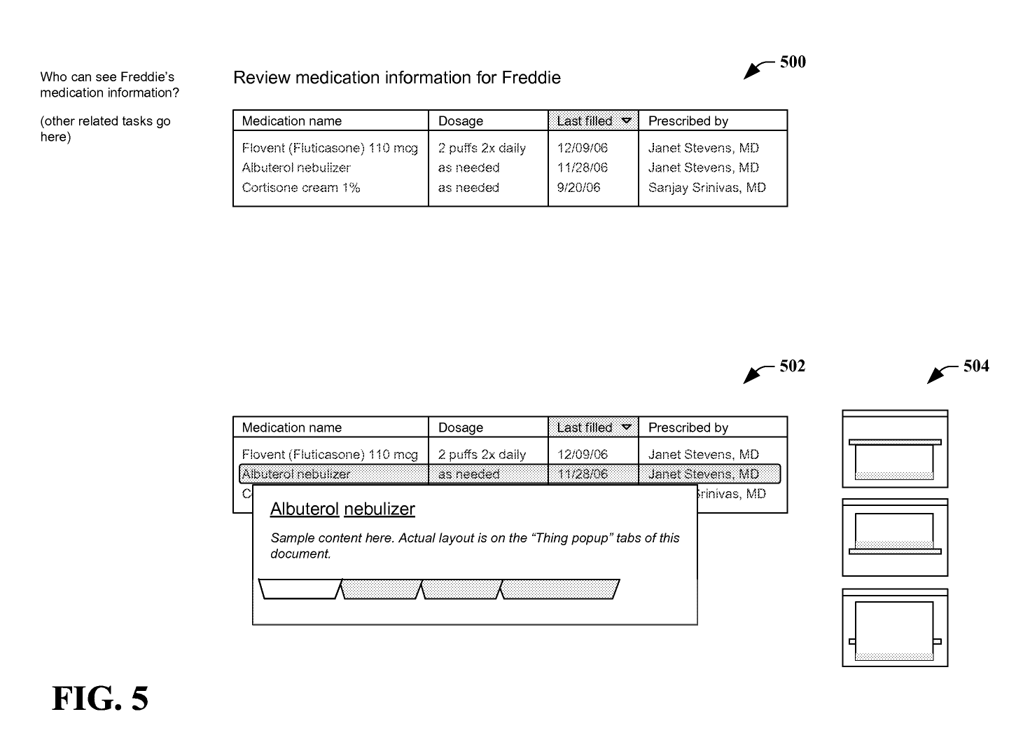

In FIG. 5, an example 500 is presented of a medication information screen in a tabular format. The layout of the tabular data, as described above, can be defined as an abstract layout by self-describing rendering information, and the UI can render the data according to the layout. The information is sortable by the fields provided and is shown as sorted by last filled date. The screen can show additional information about related tasks and such. At 502, the tabular formatted data is shown with an item selected; selection of the item pops up the tabbed window comprising further detailed information about the medication. Additionally, at 504, different configurations for the pop-up tabbed window are shown. It is to be appreciated that the subject matter described is not limited to this embodiment, rather this is one possible example of the user interface.

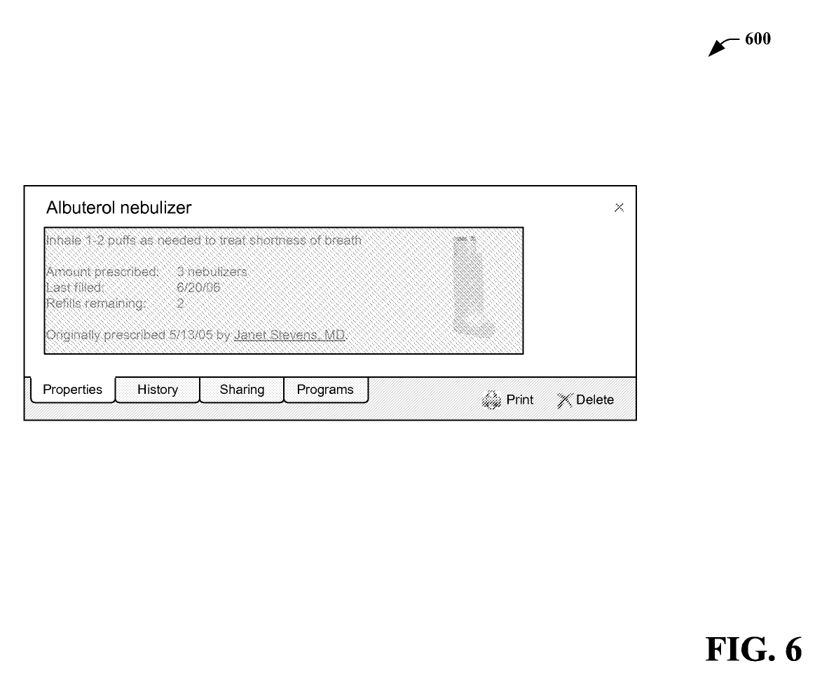

FIG. 6 shows an example 600 of a Properties tab for medication in the pop-up tabbed window. The layout of the window, as described above, can also be defined as an abstract layout by self-describing rendering information, and the UI can render the data according to the layout. Additional tabs can be defined and provided for History of use, Sharing of the data, and Programs that can be used to view the data for example. It is to be appreciated that many number of tabs can be defined having different information as defined in the layout information. The layout information can be specified by many different sources, and information can be added specific to that source and/or generic to other displaying/rendering systems as well.

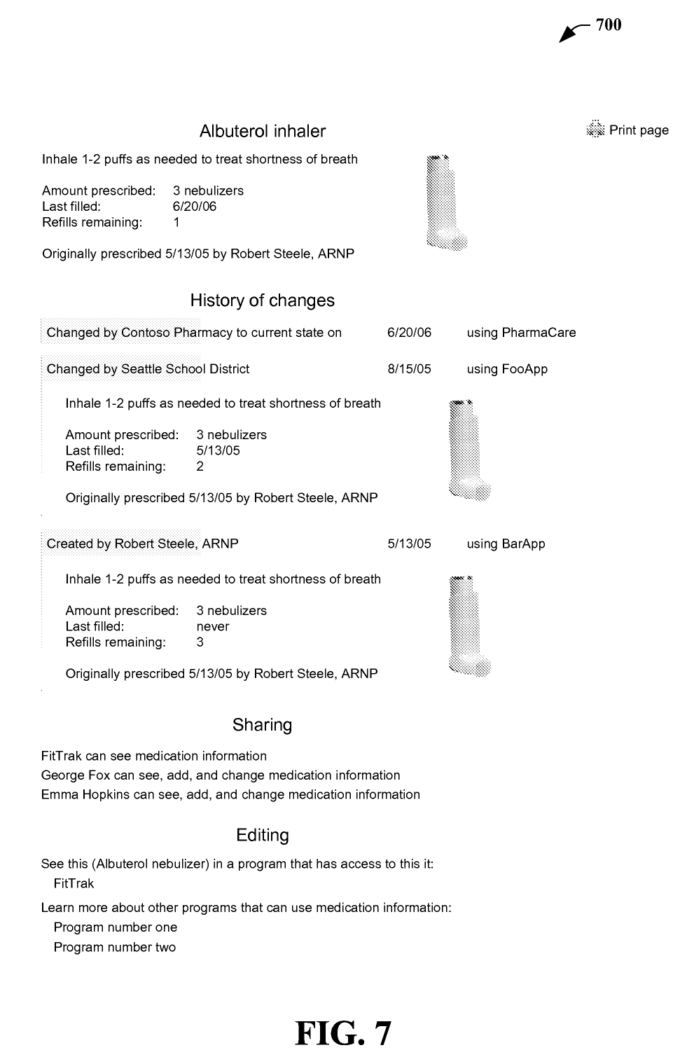

Referring to FIG. 7, an example 700 of a detailed information/printable view of the data in the tabbed window is illustrated. This screen layout can be defined in the abstract data layout resident in self-describing rendering information, for example. Additionally, the separate portions (general information, history information, permissions for sharing and editing, etc.) can be provided in the rendering information and the UI can choose how the layout of the sections (tabbed window as in FIG. 6, or all on one screen as shown here). It is to be appreciated, however, that the rendering information can be totally provided with the data in both forms.

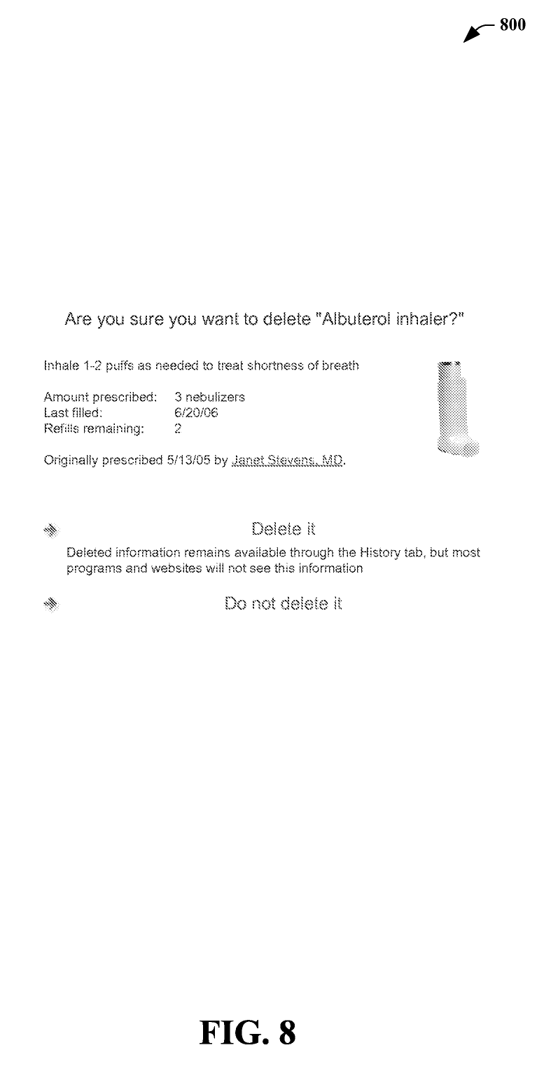

Turning to FIG. 8, an example 800 of a delete confirmation screen is displayed. Similarly to the detailed information pages, this page shows some of the general properties of the item. The layout of this page (and/or of the medical information on the page) can be provided with the self-describing rendering information.

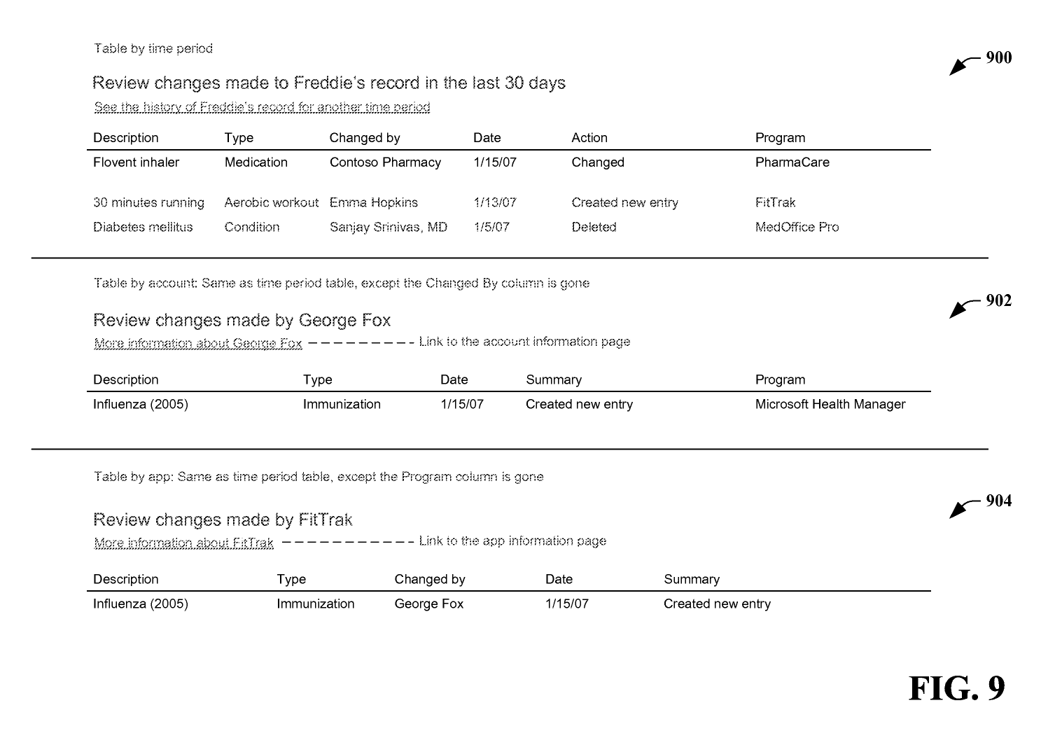

FIG. 9 shows various embodiments of historical audit data layouts. At 900, information sorted by time period is displayed; the rendering information can be provided along with the data as described above. It is to be appreciated that the platform can provide data already sorted and/or sorting instructions with the data as well. At 902, data retrieved and sorted by account is shown; the account can be for example one that made changes and/or reviewed the data. At 904, data can similarly be shown according to applications that have changed the data. In these cases, rendering information can provide rendering instruction to obtain the desired data layout. For example, if data for the last 30 days is requested, the self-describing rendering information can include code to restrict the results in this fashion, for example.

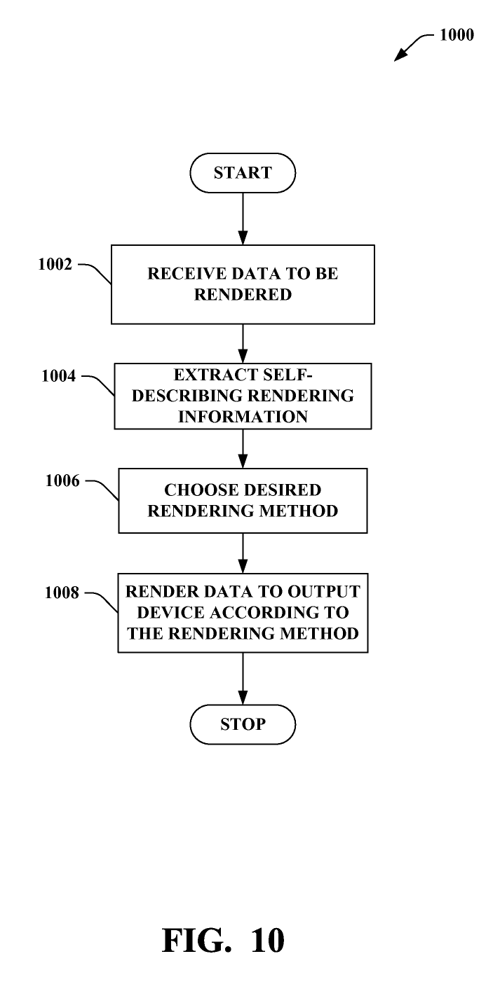

In view of the exemplary systems described supra, methodologies that may be implemented in accordance with the disclosed subject matter will be better appreciated with reference to the flow charts of FIGS. 10-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 10 shows a methodology for rendering data received by a user interface in accordance with the subject matter herein described. As described above, the data can be packaged with self-describing rendering information to aid the user interface in rendering the data as desired by the output device. At 1002, the data to be rendered is received. The data can come from a platform, for example, and originate from a request made to the platform. The platform can be a health integration network as described above. At 1004, the self-describing rendering information is extracted from the data. This information can be a schema, for example XSL, such that the data can be rendered in a text format, such as XML, HTML, RSS, flat text, and the like. It is to be appreciated that other types of schema languages can be used as well. Additionally, the self-describing rendering information can be sequential instructions, SVG, software language (such as an object-oriented language), or any code the UI can interpret to render the data. Multiple rendering information sets or instructions can be provided with given data and can be tuned to a context of the original request, such as the requesting user and/or application, for example. At 1006 the desired rendering method can be chosen from the set if multiple instructions exist. For example, in a health integration network, a request for blood pressure can originate from a user software application and a blood pressure monitor. In this example, data can be received along with at least both rendering information for a software application and for a blood pressure device (e.g. many devices can exist as well and require separate rendering instructions). The rendering instructions can be very different; for example, the rendering for the software application can be multiple layouts to choose from which are made up of XSL style sheets, for example. On the other hand, the rendering for the blood pressure monitor can be electrical signals sent from an interface device; thus the data can provide these as well and the interface device can retrieve this set of self-rendering instructions and apply it to the data before rendering the digital readout to the blood pressure monitor. This happens at 1008; data is rendered to the output device according to the selected method. In the case of the software application, the blood pressure data can be applied on the chosen XSL and displayed on the software application screen.

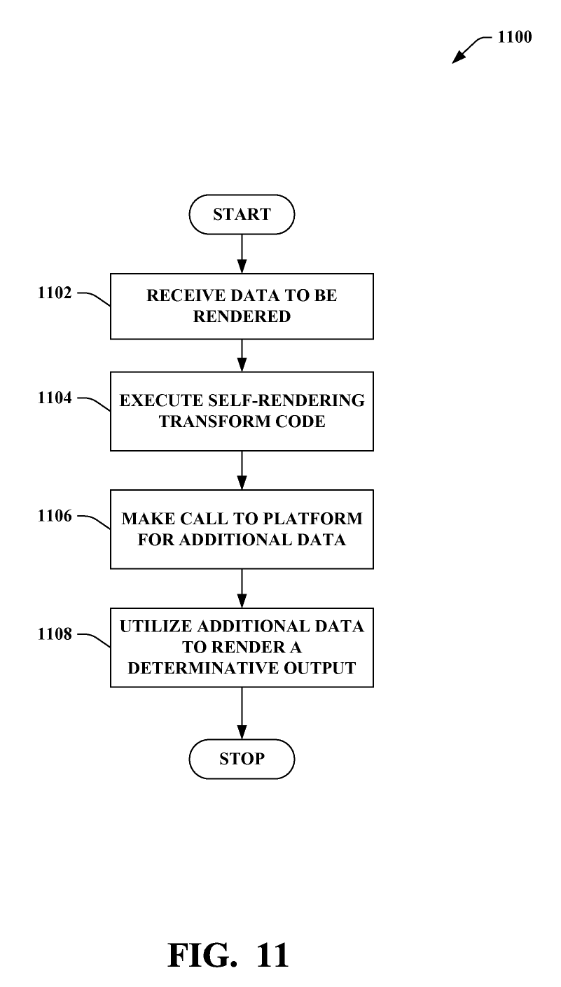

FIG. 11 illustrates a methodology 1100 that facilitates rendering data by leveraging code provided along with the data is shown. At 1102, the data to be rendered is received along with some self-describing rendering information. The rendering information can, for example, comprise software code that can be run to provide a more intelligent transform. The software code can run on the platform for example and/or cause additional data to be accessed by the platform, and at 1104 the self-rendering code is executed. As mentioned, during the execution of the code, a call can be made to the platform for additional data at 1106. This data can help make an intelligent or determinative output. For example, the code can cause additional data to be retrieved from the platform and the code can utilize the additional data.

For example, in a platform that stores health related data, a request can be initiated for information concerning medication. The platform can return the requested data along with self-describing rendering information. This information can have one or more rendering transforms with executable code. For example, one such transform can determine if the requesting user may have an allergy with the medication and mark the medication with an asterisk in that case. Thus, the code can make an additional call to the platform specifying the user and the medication, for example. The platform and/or the UI can look up the user and medication and compare allergies related to the medication (and/or an active ingredient) to allergies of the user. If an allergy concern exists, the self-describing rendering code can place an asterisk next to the medication in the rendering information created from the code, for example. Then at 1108, the additional information is utilized to render an output. The output can be to a number of devices and/or software applications as described above. Additionally, the output can be to audio devices, mechanical, electrical and/or many or imaginable devices.

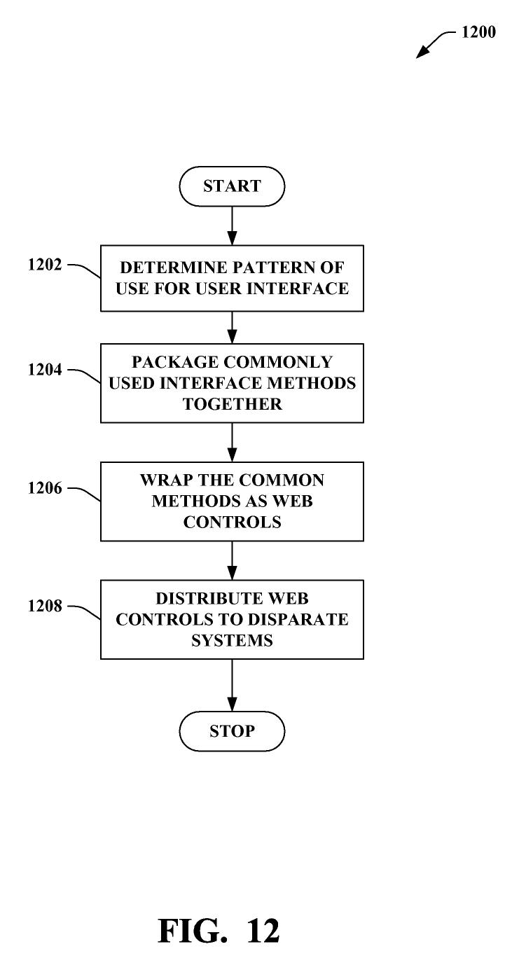

FIG. 12 shows a methodology 1200 for packaging common UI methods in web controls for distribution to disparate systems. At 1202, patterns of use for the user interface are determined. This can occur, for example, by viewing previous statistics of requests made by the user interface to a platform; additionally a determination of commonly grouped methods can be determined as well (for example where a request for a diet routine commonly follows a request for fitness routine for a given time period, these methods can be wrapped in a single web control according to the determination that they are commonly requested together). It is to be appreciated that a system can perform this analysis as well and the patterns of use can be evaluated in conjunction with thresholds. At 1204, the commonly used methods are packaged together for distribution at a disparate system. At 1206 the packaged APIs are wrapped as web controls. Such packaging and wrapping for deployment at a remote system can aid in setup at the remote system by providing a common set of methods utilized in conjunction with the platform. In this regard, need for development can be mitigated. At 1208, the web controls can be distributed to disparate systems for deployment.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

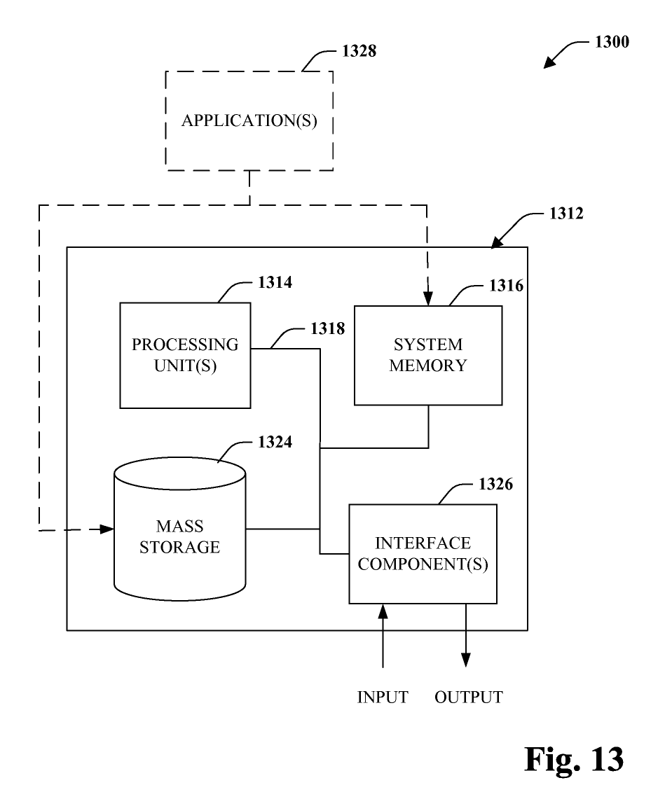

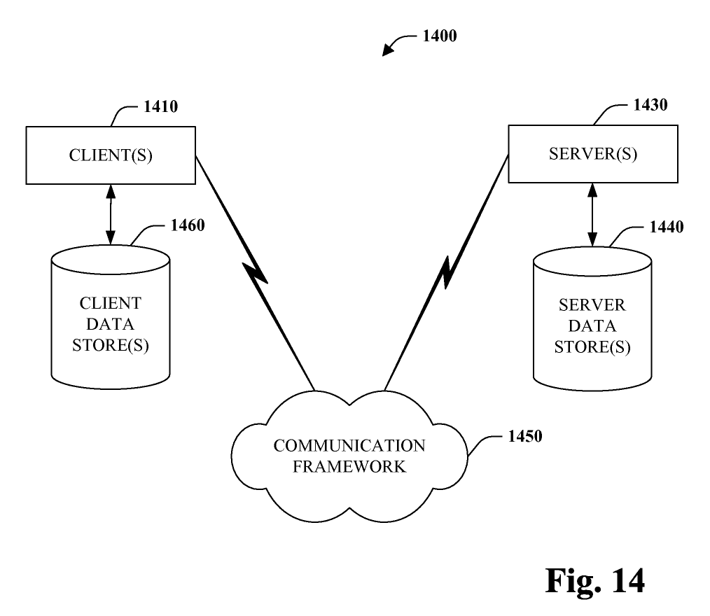

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1300 for implementing various aspects disclosed herein includes a computer 1312 (e.g., desktop, laptop, server, hand held, programmable consumer or industrial electronics . . . ). The computer 1312 includes a processing unit 1314, a system memory 1316 and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory or memory stick. In addition, mass storage 1324 can include storage media separately or in combination with other storage media.

FIG. 13 provides software application(s) 1328 that act as an intermediary between users and/or other computers and the basic computer resources described in suitable operating environment 1300. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. Here, the client(s) 1410 can correspond to program application components and the server(s) 1430 can provide the functionality of the interface and optionally the storage system, as previously described. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

By way of example, a graphical user interface (GUI) application in accordance with the UI as described herein can be executed on a client 1410. The GUI can request personal health information from one or more servers 1430 (and an API stored thereupon or accessible therefrom, for example) over the communication framework 1450. The server(s) 1430 can obtain the desired data from a data store 1440 or a plurality of data stores along with self-describing rendering information (such as a schema, program code, etc.) for example. Subsequently, the GUI can apply at least one self-describing rendering information method, code, or the like to the data and display the rendered data to the client 1410.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. An interface for outputting platform data, comprising:
a data receiving component that receives data from a platform, the received data includes at least one self-describing rendering instruction specified by the platform; and
a data rendering component that utilizes the self-describing rendering instruction to output the received data to an output device.

2. The interface of claim 1, further comprising a data requesting component that forwards a request for data from a requesting entity to the platform, the received data based at least in part on the request for data.

3. The interface of claim 2, the requesting entity is the output device.

4. The interface of claim 2, the platform determines the at least one self-describing rendering instruction from a context of the requesting entity.

5. The interface of claim 1, the output device is an auditory alarm.

6. The interface of claim 1, the output device is a personal health device.

7. The interface of claim 1, the data rendering component outputs the received data in a tabular format for viewing on a digital display by utilizing the self-describing rendering instruction.

8. The interface of claim 1, the data rendering component outputs the received data in a graphical form for viewing on a digital display by utilizing the self-describing rendering instruction.

9. The interface of claim 1, the self-describing rendering instruction comprises an XML document that is executed by the data rendering component.

10. The interface of claim 1, the platform is a health integration network comprising a plurality of databases that respectively store health related data originating from disparate sources.

11. A method for rendering platform data to disparate applications and devices, comprising:
receiving data to be rendered along with self-describing rendering information from a platform;
rendering the data to at least one application or device based at least in part on the self-describing rendering information.

12. The method of claim 11, further comprising sending a request for data to the platform on behalf of the application or device, the received is data related to the request.

13. The method of claim 12, the platform utilizes at least one value relating to a context of the request for data to provide the self-describing rendering information.

14. The method of claim 11, the data is rendered in a tabular format according to the self-describing rendering information.

15. The method of claim 11, the data is rendered to an alarm for auditory notification based on the self-describing rendering information.

16. The method of claim 11, further comprising choosing at least one of a plurality of rendering methods residing in the self-describing rendering information to be utilized in rendering the data.

17. The method of claim 11, further comprising executing software code provided in the self-describing rendering information.

18. The method of claim 17, the software code performs a request to the platform for additional information relating to the data to be rendered.

19. A system that utilizes a user interface to provide platform data to a client, comprising:
means for receiving data to be output to a display;
means for receiving self-describing rendering information related to the data;
means for selecting a rendering method from the self-describing rendering information; and
means for rendering the data to the display in a layout specified by the rendering method.

20. The system of claim 19, the rendering method is chosen based at least in part on a context of a request made for the data.
